(19) United States
(12) Patent Application Publication
(10) Pub. No.: US 2005/0206587 A1
(43) Pub. Date: Sep. 22, 2005

(54) Plasma display apparatus and image processing method thereof

(75) Inventor: Seung Chan Baek, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/081,389

(22) Filed: Mar. 15, 2005

(30) Foreign Application Priority Data
Apr. 19, 2004 (KR) 10-2004-0026663
Mar. 18, 2004 (KR) 10-2004-0018606

(51) Int. Cl. G09G 3/28

(52) U.S. Cl. 345/60

(57) ABSTRACT

The present invention relates to a plasma display apparatus, and more particularly, to a plasma display apparatus for expressing images by processing input image signals and an image processing method thereof. The plasma display apparatus for expressing images by processing image signals comprises: an inverse gamma correction unit linearly transforming a luminance value depending on the gray scale of an image signal by inverse gamma correction of input image signal data; and a halftoning unit masking at least two dither mask patterns in random order with respect to the inverse gamma corrected image signal data.

This Nonprovisional application claims priority under 35 U.S.C. § 119(a) on Patent Application No. 10-2004-0018606 filed in Korea on Mar. 18, 2004 and Patent Application No. 10-2004-0026663 filed in Korea on Apr. 19, 2004, the entire contents of which are hereby incorporated by reference.

### BACKGROUND OF THE INVENTION

1. Field of the Invention

The present invention relates to a plasma display apparatus, and more particularly, to a plasma display apparatus for expressing images by processing input image signals and an image processing method thereof.

2. Background of the Related Art

Generally, a plasma display apparatus is such a device in which a partition wall formed between front and back panels forms each of unit cells, each cell being filled by an inert gas containing a main discharge gas, such as neon(Ne), helium(He) or a mixed gas of neon and helium(Ne+He), and a small amount of xenon. When discharged by a high frequency voltage, the inert gas generates vacuum ultraviolet rays, and makes fluorescent material formed between partition walls luminescent, thereby realizing an image. Such a plasma display panel is spotlighted as a next generation display apparatus due to its thin and lightweight construction.

FIG. 1 is a view showing a structure of a general plasma display panel.

As shown in FIG. 1, the plasma display panel comprises a front substrate 100 having a plurality of scan electrodes 102 and sustain electrodes 103 arranged in pairs on a front glass 101, which is a display surface for displaying an image, and a rear substrate 110 having a plurality of address electrodes 113 arranged on a rear glass 111, which is the back surface thereof, so as to cross the plural pairs of scan electrodes and sustain electrodes, the front substrate 100 and the rear substrate 110 being coupled parallel to each other with a predetermined distance therebetween.

The front substrate 100 is covered with at least one dielectric layer 104 that limits the discharge current of the scan electrode and the sustain electrode and makes each of the electrodes insulated, the scan electrodes 102 and the sustain electrodes 103 being adapted to cause mutual discharge in a discharge cell and keep the luminescence of cells each including a transparent electrode a of ITO(Indium Thin Oxide) electrode and a bus electrode b made of metal. A protective layer 105 with magnesium oxide(MgO) deposited thereto is formed on the front surface of the dielectric layer 104 in order to make the discharge condition easier.

Barrier ribs 112 of stripe type (or well type) are arranged in parallel on the rear substrate 110 so as to form a plurality of discharge spaces, i.e., discharge cells. A plurality of address electrodes 113 generating vacuum ultraviolet ray by performing address discharge are arranged parallel to the barrier ribs 112. RGB fluorescent material 114 for emitting visible rays to display images during address discharge is coated on the upper side of the rear substrate 110. A dielectric layer 115 for protecting the address electrodes 113 is formed between the address electrodes 113 and the fluorescent material 114.

FIG. 2 is a view showing a method of expressing images of a prior art plasma display apparatus.

As shown in FIG. 2, the plasma display apparatus realizes images by dividing one frame period into a plurality of subfields having different numbers of discharges, and making the plasma display panel luminous during a subfield period corresponding to a gray scale of an input image signal.

Each of the subfields is divided into a reset period for bringing about discharge uniformly, an address period for selecting a discharge cell, and a sustain period for implementing the gray scale according to the number of discharges. For example, when displaying an image with 256-level gray scale, a period (16.67 ms) of frame that corresponds to {fraction( 1/60)} second is divided into eight subfields.

Moreover, each of the eight subfields is divided into a reset period, an address period, and a sustain period. Here, the sustain periods of each of the subfields have increasing intervals in the ratio of 2n(n=0, 1,2,3,4,5,6,7). Thus, the gray scale is implemented by combination of subfields having different sustain periods.

FIG. 3 is a graph comparing the luminance properties of a plasma display channel and a cathode-ray tube.

As shown in FIG. 3, a cathode-ray tube and a liquid crystal display generally have the nonlinear luminance properties because they represent a desired gray scale by controlling light being displayed in an analog manner with respect to an input video signal. In contrast, the plasma display apparatus has the linear luminance properties because it represents a gray scale by modulating the number of optical pulses utilizing a matrix array of discharge cells which could be switched on or off. The gray scale representation of such a plasma display apparatus is called a PWM(Pulse Width Modulation) method.

At this time, since the brightness of the display relative to current is proportional to a multiplier 2.2, the display apparatus sends image signals, which are input from the outside, corresponding to the inverse of the multiplier 2.2. Thus the plasma display apparatus having the linear brightness is provided with an inverse gamma correction unit for inverse gamma correcting an image signal input from the outside.

FIG. 4 is a graph for explaining an inverse gamma correction in the prior art plasma display apparatus.

In FIG. 4, a target luminance represents an ideal inverse gamma result desired to be corrected, an actual luminance represents a measured luminance value shown as a result of inverse gamma correction, and a PDP luminance represents a luminance value less than 3 measured without inverse gamma correction applied.

As shown in FIG. 4, as for the target luminance, gray scales of 61 steps from 0 to 60 are represented by different luminance values. In contrast, as for the actual luminance, gray scales of 61 steps from 0 to 60 are represented only by 8 luminance values. Thus, when inverse gamma correction is implemented in the plasma display apparatus, it becomes impossible to achieve sufficient gray scale representation to thus generate a contour noise where image are lumped together.

To improve insufficient gray scales of the plasma display apparatus, the plasma display apparatus is provided with a halftoning unit which implements halftoning such as dithering or error diffusion or the like.

Firstly, the error diffusion is a method for dealing with corrections for discarded errors by making an error generated when quantizing a corresponding pixel affect adjacent pixels. The error diffusion is problematic in that an error diffusion pattern is generated in a uniform gray scale due to a constant error diffusion coefficient since a constant error diffusion coefficient is set for adjacent pixels and repeated for each line and frame.

Next, the dithering method will be described as in FIGS. 5a and 5b.

FIGS. 5a and 5b are views showing the dithering method of the prior art plasma display apparatus. FIG. 5a shows four patterns for a prior art 4×4 dither mask, and FIG. 5b shows a dither noise shaped by the 4×4 dither mask patterns.

As shown in FIG. 5a, the dithering method is a method of discriminating whether a carry is generated for an individual pixel by comparison between the gray scale of the pixel and a specific threshold of a dither mask. Pixels having a carry generated therein are turned on and the other pixels are turned off to increase insufficient gray scale representation capability.

Moreover, the dithering method is a method of making a contour noise not noticeable by adding a proper noise. In the prior art, a three-dimensional dither mask pattern is used which corresponds to a plurality of frames, a plurality of lines and a plurality of columns. If one pattern having the same gray scale is used for each frame, dither noise that makes the pattern noticeable by human eyes is generated. Thus, in FIG. 5a, four frames are periodically repeated by using dither mask patterns of four types.

As shown in FIG. 5b, the dither mask patterns are periodically used in turn for each frame. That is, dither mask pattern 1 is used for a first frame, and thereafter, dither mask pattern 2 is used for a second frame. If the frames are accumulated temporally when data of an input image signal is a still image, the pixels are turned on uniformly across the entire area.

However, if the frames are accumulated temporally when data of an input image signal is a moving image, the pixels are partially turned on. There is a problem that, in case that one of the pixels moves in the frame of dither mask pattern 2, dither noise looking like stripes is generated.

### SUMMARY OF THE INVENTION

Accordingly, the present invention is directed to solve at least the problems and disadvantages of the background art.

An object of the present invention is to provide a plasma display apparatus capable of representing insufficient gray scale and an image processing method thereof by enhancing a plasma display apparatus and an image processing method thereof.

Another object of the present invention is to provide a plasma display apparatus capable of suppressing a dither noise generated upon expressing image signals and an image processing method thereof by enhancement of a plasma display apparatus and an image processing method thereof.

According to one embodiment of the present invention, there is provided a plasma display apparatus comprising: an inverse gamma correction unit linearly transforming a luminance value depending on the gray scale of an image signal by inverse gamma correction of input image signal data; and a halftoning unit masking at least two dither mask patterns in random order with respect to the inverse gamma corrected image signal data.

According to the embodiment of the present invention, there is provided an image processing method of a plasma display apparatus, comprising: an inverse gamma correction step of linearly transforming a luminance value depending on the gray scale of an image signal by inverse gamma correction of input image signal data; and a halftoning step of masking at least two dither mask patterns in random order with respect to the inverse gamma corrected image signal data.

The present invention has the effect of improving gray scale representation capability by enhancement of a plasma display apparatus and an image processing method thereof.

Furthermore, the present invention has the effect of suppressing a dither noise generated when expressing image signals by enhancement of a plasma display apparatus and an image processing method thereof.

### BRIEF DESCRIPTION OF THE DRAWINGS

The invention will be described in detail with reference to the following drawings in which like numerals refer to like elements:

FIG. 1 is a view showing a structure of a general plasma display panel;

FIG. 2 is a view showing a method of expressing images of a prior art plasma display apparatus;

FIG. 3 is a graph comparing the luminance properties of a plasma display channel and a cathode-ray tube.

FIG. 4 is a graph for explaining an inverse gamma correction in the prior art plasma display apparatus.

FIGS. 5a and 5b are views showing the dithering method of the prior art plasma display apparatus;

FIG. 6 is a block diagram schematically showing a plasma display apparatus according to one embodiment of the present invention;

FIG. 7 is a block diagram for explaining the operation characteristics of a halftoning unit according to the embodiment of the present invention;

FIG. 8 is a view for explaining a modified halftoning unit according to the embodiment of the present invention;

FIG. 9 is a view for explaining another modified halftoning unit according to the embodiment of the present invention;

FIG. 10 is a view for explaining dither mask patterns shown by the image processing method of the plasma display apparatus according to the embodiment of the present invention; and

FIGS. 11a and 11b are views showing dither mask patterns according to another image processing method of the embodiment of the present invention.

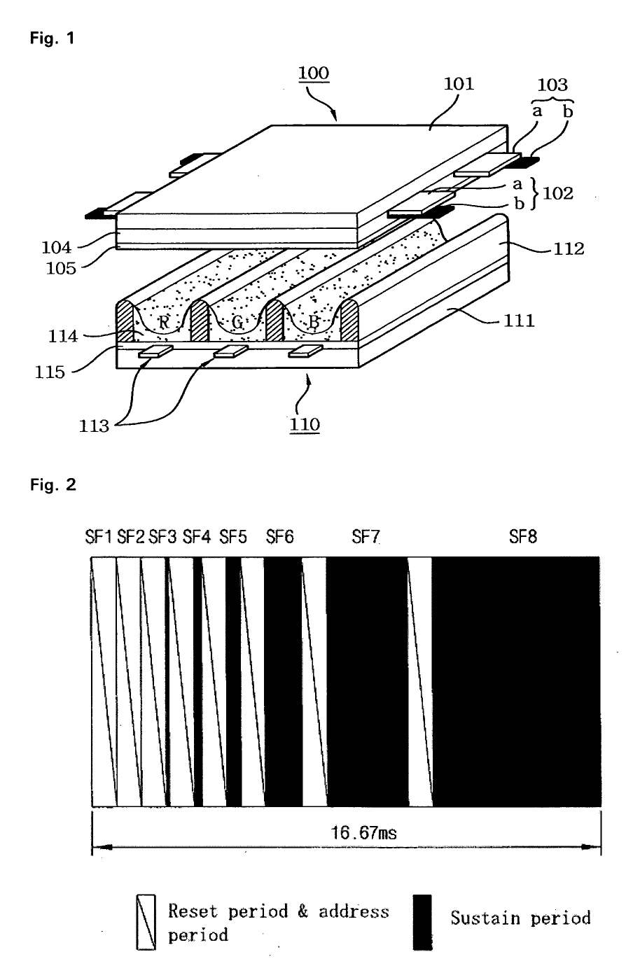

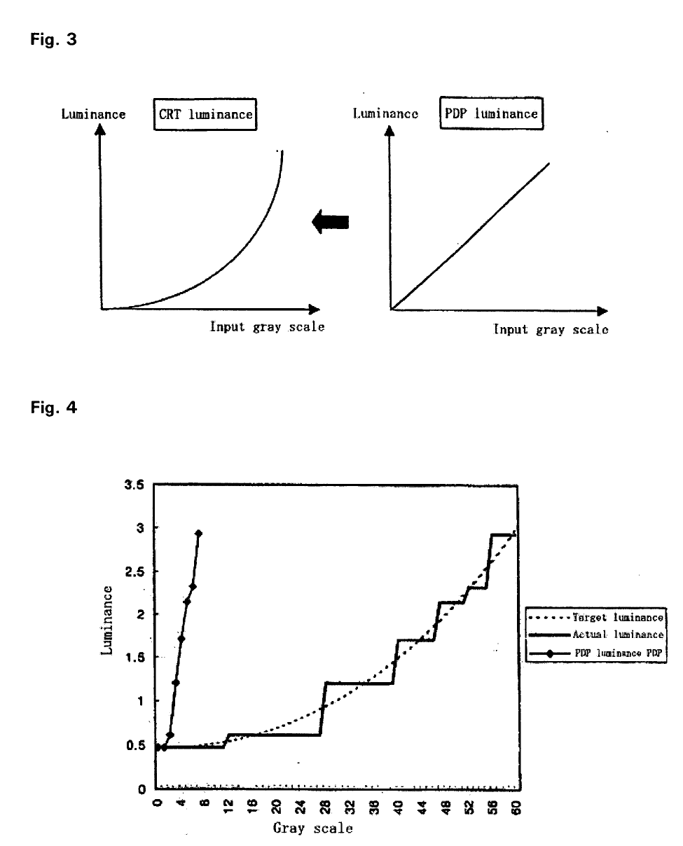

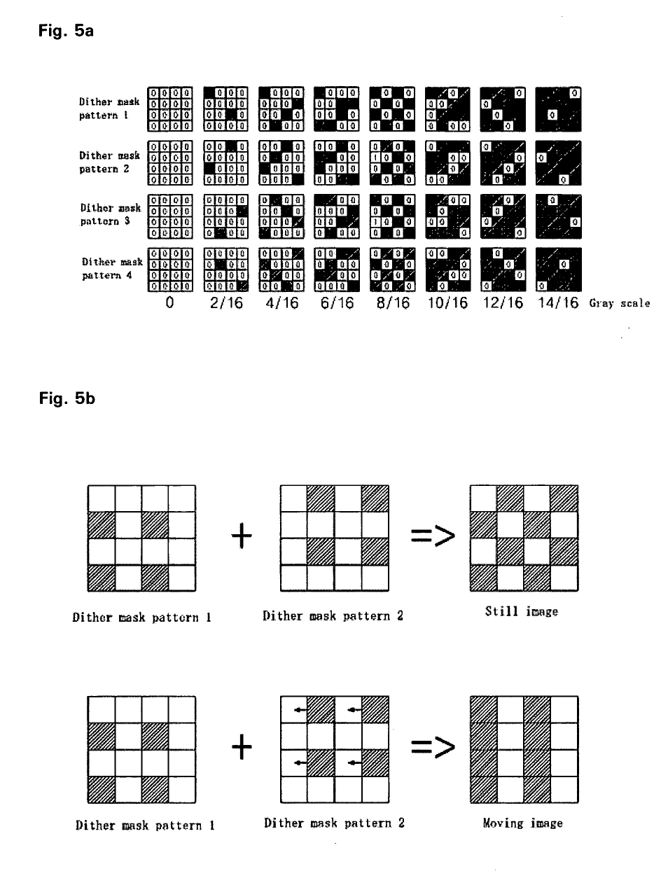

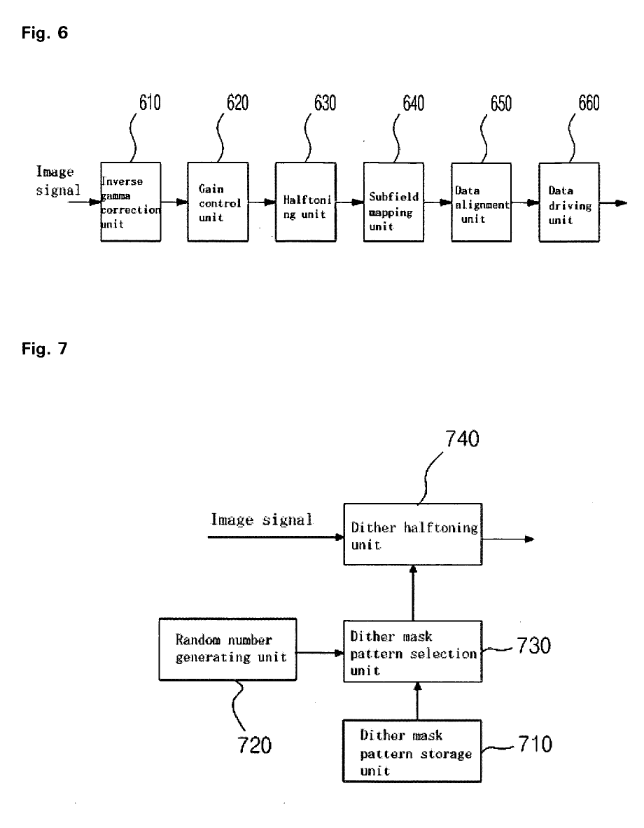

### DETAILED DESCRIPTION OF THE PREFERRED EMBODIMENTS

Preferred embodiments of the present invention will be described in a more detailed manner with reference to the drawings.

A plasma display apparatus for according to an embodiment of the present invention comprises, an inverse gamma correction unit for linearly transforming a luminance value according to the gray scale of the image signal by performing inverse gamma correction with input image signal data; and a halftoning unit for masking at least two dither mask patterns in random order for the image signal data which is inverse gamma corrected.

The halftoning unit comprises a dither mask pattern storage unit for storing the dither mask pattern; a random number generating unit for generating the same number of random numbers as the number of the dither mask patterns; and a dither mask pattern selection unit for selecting the dither mask patterns corresponding to the random numbers.

A plasma display apparatus according to an aspect of the present invention further comprises a motion detection unit for detecting the motion quantity of the image signal, wherein if the motion quantity of the previous frame N-1 detected from the motion detection unit and the motion quantity of the current frame N are the same, the current frame uses a dither mask pattern different from the dither mask pattern of the previous frame.

A plasma display apparatus according to an aspect of the present invention further comprises an APL calculation unit calculating the APL(average picture level) of the image signal input for each frame; and a block size setting unit setting the size of a block masked by a dither mask pattern according to the APL.

As the APL is decreased, the block size setting unit sets in smaller size, as the APL is increased, the block size setting unit sets in greater size.

An image processing method for a plasma display apparatus displaying an image by processing an image signal according to an embodiment of the present invention comprises an inverse gamma correction step of linearly transforming a luminance value according to the gray scale of an image signal by inverse gamma correction of input image signal data; and a halftoning step of masking at least two dither mask patterns in random order with respect to the inverse gamma corrected image signal data.

An image processing method for a plasma display apparatus displaying an image by processing an image signal according to an embodiment of the present invention further comprises a dither mask pattern storage step of storing the dither mask pattern; a random number generating step of generating the same number of random numbers as the number of the dither mask patterns; and a dither mask pattern selection step of selecting the dither mask patterns corresponding to the random numbers.

An image processing method for a plasma display apparatus displaying an image by processing an image signal according to an embodiment of the present invention further comprises a motion detection step of detecting the motion quantity of an image signal, wherein if the motion quantity of the previous frame N-1 detected from the motion detection unit and the motion quantity of the current frame N are the same, the current frame uses a dither mask pattern different from the dither mask pattern of the previous frame.

An image processing method for a plasma display apparatus displaying an image by processing an image signal according to an embodiment of the present invention further comprises an APL calculation step of calculating the APL(average picture level) of an image signal input for each frame; and a block size setting step of setting the size of a block masked by a dither mask pattern according to the APL.

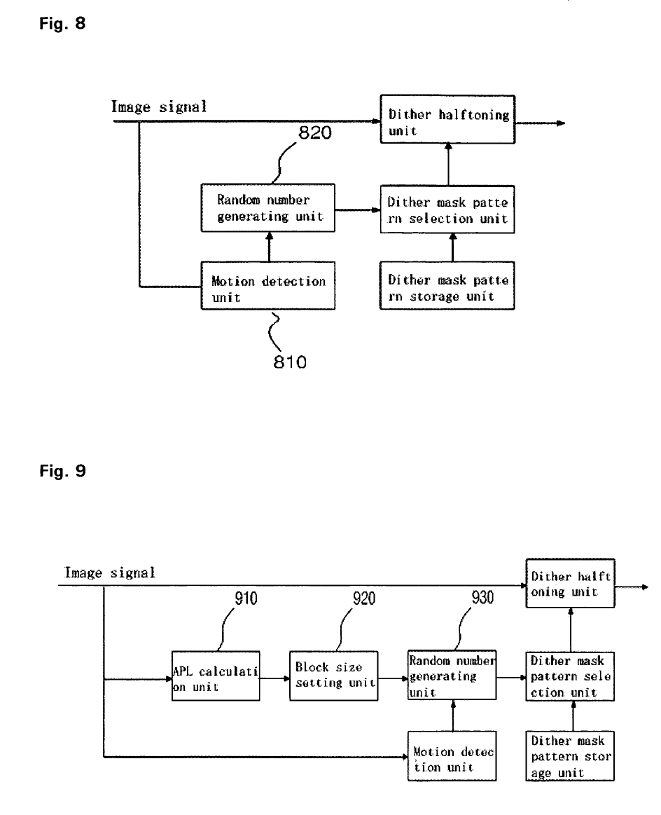

FIG. 8 is a view for explaining a modified halftoning unit according to the embodiment of the present invention.

As shown in FIG. 8, the modified halftoning unit according to the embodiment of the present invention further comprises a motion detection unit 810 detecting the motion quantity of an image signal.

If the motion quantity of the previous frame N-1 detected from the motion detection unit and the motion quantity of the current frame N are the same, that is to say, an image signal is detected in the form of a still image, the current frame uses a dither mask pattern different from the dither mask pattern of the previous frame. For this, the information on the still image detected by the motion detection unit is input into the random number generating unit 820, thus to prevent the same random number from being generated consecutively in case of still image.

FIG. 9 is a view for explaining another modified halftoning unit according to the embodiment of the present invention.

As shown in FIG. 9, the another modified halftoning unit according to the embodiment of the present invention comprises an APL calculation unit 910 and a block size setting unit 920.

The APL calculation unit 910 calculates the APL(average picture level) of an image signal input for each frame.

Generally, a plasma display apparatus comprises an APL calculation unit 910 for controlling power consumption to a certain level. Thus, in the embodiment of the present invention, it is preferred to be provided with the information on APLs from the APL calculation unit already in use without having a separate APL calculation unit.

The block size setting unit 920 sets the size of a block masked by a dither mask pattern according to a calculated APL, i.e., the number of pixels masked by a dither mask pattern among adjacent pixels. At this moment, the smaller the APL is, the smaller block size the block size setting unit 920 sets, and the greater the APL is, the greater block size it sets.

In other words, as the APL is smaller, the size of a block is set smaller, which allows the randomness of dither mask patterns more frequent. The information on a block size set in the block size setting unit 920 is input into the random number generating unit 930.

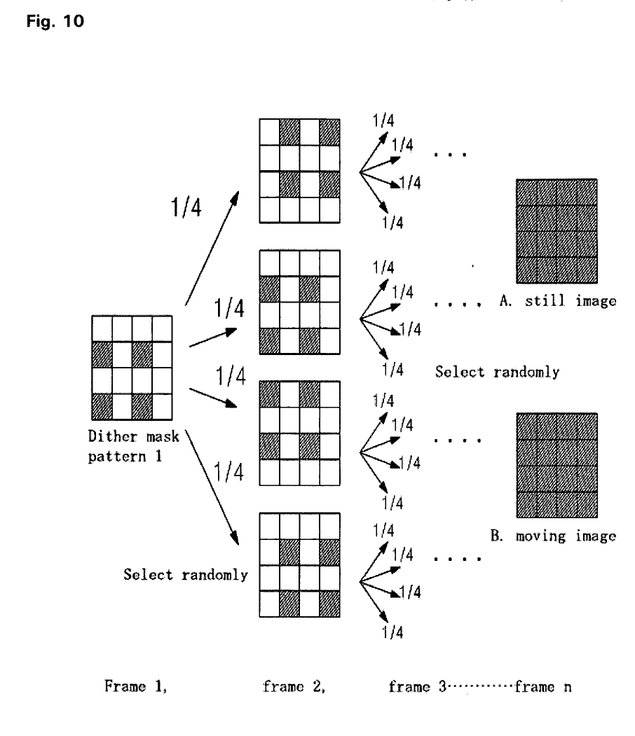

FIG. 10 is a view for explaining dither mask patterns shown by the image processing method of the plasma display apparatus according to the embodiment of the present invention.

As shown in FIG. 10, four patterns of a dither mask are used for each frame in random order.

If there are four dither mask patterns, one of the four patterns 1 to 4 is selected randomly. If the dither mask pattern of the current frame is the first one, the number of the mask pattern to be applied to the next frame is determined randomly and thus it is not possible to tell which pattern comes next.

Further, the number of cases of selection of a dither mask pattern for the next frame is the same as the total number of dither mask patterns having the same gray scale. If the first pattern is being applied to the current frame, the probability of selecting one of the four dither mask patterns for the next frame will be one-fourth.

In FIG. 10, in case that dither mask patterns are applied randomly, one of the four patterns can be the second dither mask pattern. As the frame goes forward continuously, the order of use of the dither mask patterns becomes more random, and if the frames are accumulated temporally, this can render the usual effect of turning on pixels randomly.

Therefore, the entire pixels of a still image are uniformly turned on as shown in A, and the entire pixels of a moving image are also uniformly turned on as shown in B. Subsequently, dither noise looking like stripes are not seen.

At this moment, in order to prevent the same dither mask pattern from being used in a still image, the halftoning step according to the embodiment of the present invention further comprises a motion detection step of detecting the motion quantity of an image signal. If the motion quantity of the previous frame N−1 detected from the motion detection unit and the motion quantity of the current frame N are the same, the current frame uses a dither mask pattern different from the dither mask pattern of the previous frame.

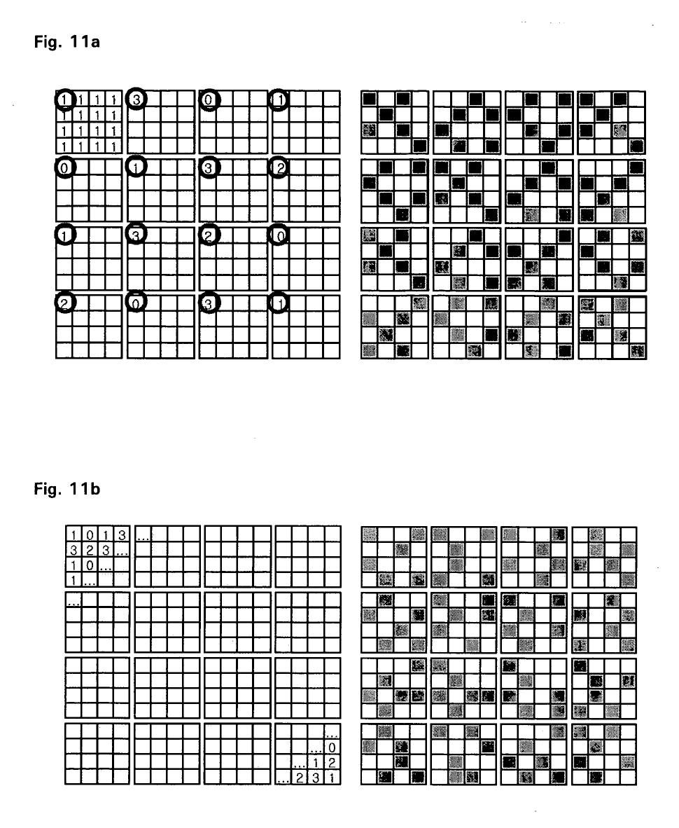

Furthermore, the image processing method according to the embodiment of the present invention can render a spatially random property as shown in FIGS. 11a and 11b.

FIGS. 11a and 11b are views showing dither mask patterns according to another image processing method of the embodiment of the present invention. FIG. 11a shows the phase of dither mask patterns when 4×4 blocks are used, and FIG. 11b shows the phase of dither mask patterns when a 1×1 block is used.

As shown in FIG. 11a, one screen is divided into 4×4 blocks to generate a random number for each block. At this moment, as described above, one type of pattern is used for one block. Further, random numbers are generated at the position indicated as ∘, and accordingly the type of dither mask pattern is determined. The moment a corresponding pixel is input, any one of the four patterns is determined and the same mask pattern is used in one 4×4 block.

In the embodiment of the present invention, at least 1×1 blocks can be used according to the size of a block. In FIG. 11b, a random number is generated for each pixel, and thus the type of dither mask pattern corresponding to the random number is determined. Also in the 1×1 blocks, the moment a corresponding pixel is input, any one of the four patterns is determined.

In this way, in case that 1×1 blocks are applied, the dither mask pattern becomes the most random one, to reduce the noise of the dither mask pattern to the minimum. The size of a block is determined differently according to the APL of an image signal input from the block size setting unit.

Accordingly, halftoning noise generated upon halftoning can be reduced, and contour noise generated due to inverse gamma correction can be eliminated, thereby improving gray scale representation capability.

The invention being thus described, it will be obvious that the same may be varied in many ways, Such variations are not to be regarded as a departure from the spirit and scope of the invention, and all such modifications as would be obvious to one skilled in the art area intended to be included within the scope of the following claims.

1. A plasma display apparatus for displaying an image by processing an image signal, comprising:
an inverse gamma correction unit for linearly transforming a luminance value according to the gray scale of the image signal by performing inverse gamma correction with input image signal data; and
a halftoning unit for masking at least two dither mask patterns in random order for the image signal data which is inverse gamma corrected.

2. The plasma display apparatus as claimed in claim 1, wherein the halftoning unit comprises:
a dither mask pattern storage unit for storing the dither mask pattern;
a random number generating unit for generating the same number of random numbers as the number of the dither mask patterns; and
a dither mask pattern selection unit for selecting the dither mask patterns corresponding to the random numbers.

3. The plasma display apparatus as claim in claim 1, further comprising a motion detection unit for detecting the motion quantity of the image signal,
wherein if the motion quantity of the previous frame N−1 detected from the motion detection unit and the motion quantity of the current frame N are the same, the current frame uses a dither mask pattern different from the dither mask pattern of the previous frame.

4. The plasma display apparatus as claim in claim 1, further comprising
an APL calculation unit calculating the APL(average picture level) of the image signal input for each frame; and
a block size setting unit setting the size of a block masked by a dither mask pattern according to the APL.

5. The plasma display apparatus as claim in claim 4, wherein as the APL is decreased, the block size setting unit sets in smaller size, as the APL is increased, the block size setting unit sets in greater size.

6. An image processing method for a plasma display apparatus displaying an image by processing an image signal, comprising:
an inverse gamma correction step of linearly transforming a luminance value according to the gray scale of an image signal by inverse gamma correction of input image signal data; and
a halftoning step of masking at least two dither mask patterns in random order with respect to the inverse gamma corrected image signal data.

7. The method as claimed in claim 6, wherein the halftoning step further comprises:
a dither mask pattern storage step of storing the dither mask pattern;
a random number generating step of generating the same number of random numbers as the number of the dither mask patterns; and
a dither mask pattern selection step of selecting the dither mask patterns corresponding to the random numbers.

8. The method as claim in claim 6, wherein further comprising a motion detection step of detecting the motion quantity of an image signal,
wherein if the motion quantity of the previous frame N−1 detected from the motion detection unit and the motion quantity of the current frame N are the same, the current frame uses a dither mask pattern different from the dither mask pattern of the previous frame.

9. The method as claimed in claim 6, wherein further comprising
an APL calculation step of calculating the APL(average picture level) of an image signal input for each frame; and
a block size setting step of setting the size of a block masked by a dither mask pattern according to the APL.

10. The method as claim in claim 9, in the block size setting step, wherein as the APL is decreased, the block size setting unit sets in smaller size, as the APL is increased, the block size setting unit sets in greater size.
